(19) United States
(12) Patent Application Publication
(10) Pub. No.: US 2022/0053968 A1
(43) Pub. Date: Feb. 24, 2022

(54) FROTHING CONTAINER AND METHOD OF CREATING A FROTHED BEVERAGE

(71) Applicant: Koninklijke Douwe Egberts B.V., Utrecht (NL)

(72) Inventors: Andrew Charles Bentley, Banbury (GB); Harrison Lloyd Woodall, Banbury (GB)

(21) Appl. No.: 17/415,661

(22) PCT Filed: Dec. 11, 2019
(86) PCT No.: PCT/EP2019/084729

§ 371 Date: Jun. 17, 2021

(30) Foreign Application Priority Data
Dec. 21, 2018 (GB) 1821099.7

(51) Int. Cl. A47J 31/44; A47J 43/27

(52) U.S. Cl. CPC A47J 31/4496; A47J 43/27; A47J 31/4489

(57) ABSTRACT

A container for frothing a beverage or component of a beverage, comprising a side wall and a base which define an inner volume, and an opening for filling said inner volume with said beverage or component, characterised in that an interior surface of said base and/or side wall comprises at least a primary protrusion and/or a primary depression, connected thereto and/or formed therein.

### TECHNICAL FIELD OF THE INVENTION

The present invention relates to containers for frothing a beverage. The present invention further relates to methods of creating a frothed beverage with frothing containers; and uses of frothing containers. The present invention finally relates to apparatuses comprising frothing containers and steam wands.

### BACKGROUND TO THE INVENTION

It is well known to use frothing containers (also called jugs) to generate micro-foam from fresh and/or UHT dairy and/or non-dairy milks.

Using conventional froth wands connected to standard coffee machines, a stream of steam is sent into milk in a frothing container, warming the beverage and incorporating air which allows the generation of a layer of foam.

This foam layer needs to present a high thickness, homogeneity and longevity to be appreciated by consumers who like to enjoy beverage preparations such as cappuccino, flat white and/or chocolate preparations.

These conventional containers nevertheless require great experience from the operator to generate such a high-quality layer of foam which essentially consists of micro-bubbles incorporated into a milk-water emulsion.

In fact, during the injection of steam from the froth wand, the operator needs to simultaneously swill the milk inside the container to allow the incorporation of steam and air into the milk and generate the micro-bubbles. This operation requires a certain level of ability to obtain the desired micro-foam, swilling the beverage inside the jug while simultaneously checking the correct temperature inside the container in order not to burn the beverage. Once the desired temperature is reached (between 60-80° C.) the operator stops the injection of steam and pours the resultant foam over the beverage preparations to be served.

The operation of foaming milk furthermore creates a safety risk due to the fact the operator must handle the container while steam is continuously injected.

It would be therefore advantageous to provide a solution which would mimic the behaviour and/or results of using known foaming jugs but provide easy use.

It would be furthermore advantageous to provide a solution which would overcome safety issues.

In addition, it would be advantageous to provide an easy to use solution which would ensure a high-quality foam layer, by simply positioning a filled jug beneath a steam stream without needing further manual operation of the jug by the operator.

Finally, it would be advantageous to provide a solution which do not requires the operator to focus on the jug during the foaming step, allowing to save operator's time.

It is therefore an aim of embodiments of the invention to satisfy the highly-felt need of an easy to use foaming container to overcome or mitigate at least one problem of the prior art whether disclosed herein or not.

### SUMMARY OF THE INVENTION

According to a first aspect of the invention there is provided a container for frothing a beverage comprising a side wall and a base which define an inner volume, and an opening for filling said inner volume with a beverage, characterised in that the interior surface of said base and/or side wall comprises at least a primary protrusion and/or a primary depression, connected thereto and/or formed therein.

In some embodiments the primary protrusion may comprise a convex protrusion and/or the primary depression may comprise a concave depression. In some embodiments the primary protrusion comprises a dome or dome-shaped protrusion extending from the base. In other embodiments the primary depression may comprise a well or pocket formed in the base, which in some embodiments may be dome-shaped.

In some embodiments said base, primary protrusion and/or primary depression may further comprise an impingement. Said impingement may comprise a secondary protrusion and/or secondary depression, which may extend from the primary protrusion to into the primary depression, and may be arranged to split the flow of fluid flowing towards the primary protrusion, primary depression and/or base of the container. The impingement may thus generate turbulence in the flow of steam exiting the froth wand, in particular close to the primary protrusion, primary depression and/or base of the container.

In preferred embodiments the primary protrusion may comprise a convex protrusion and the impingement may be in the form of a secondary protrusion which extends from the convex protrusion. In some embodiments the or each secondary protrusion may be positioned centrally with respect to the convex protrusion and/or said base. In such embodiments the combination of a primary convex protrusion, from which extends one or more secondary protrusions, creates a particularly effective turbulence generating surface for steam from a steam wand to be split and form desired bubbles or microbubbles.

In further embodiments the secondary protrusion and/or depression may be independently selected from the group of: a V-shaped cross-sectional protrusion or depression, a U-shaped cross-sectional protrusion or depression, a hemisphere, a spike, a cone, a bead, and a wedge.

The or each impingement may have a length of between 1 mm and 50 mm or of between 1% and 50% of the height of the inner volume of the container.

The secondary protrusion or depression may have a height of no more than 50%, 40%, 30%, 25% or 20% of the height of the primary protrusion or depression.

The secondary protrusion or depression may extend no more than 3 cm, 2 cm, 1.5 cm or 1 cm from the primary protrusion or into the primary depression.

In some embodiments the primary protrusion and/or depression may be integrally formed with the base and/or side wall, or fixedly connected thereto. In other embodiments the primary protrusion and/or depression may comprise an insert removably connected to the side wall and/or the base.

In some embodiments, the secondary protrusion and/or depression may be connected to or formed into said insert. The insert may comprise a base and/or side wall connector, such as hook, resilient clamp, bayonetted connector, threaded connector (such as a screw thread) and/or snap on connector.

The insert may comprise a frame or basket on which is formed or connected the primary protrusion and/or depression. In some embodiments the insert may comprise a substantially cylindrical insert having a base and peripheral side wall, with the primary protrusion and/or depression on the base of the cylinder.

The primary protrusion, primary depression and/or base may comprise a plurality of impingements. Said plurality of impingements may be arranged in an ordered pattern. The pattern may be an ordered matrix, such as 2×1, 2×2, 3×1, 3×2, 3×3, 4×1, 4×2, 4×3, 4×4 or the like, for example, especially at least a 2×2 matrix. The pattern may comprise a swirl, spiral, circle, regular polygonal shape, or the like, for example. In further embodiments the plurality of impingements may be randomly arranged.

In some embodiments the or each impingement may be arranged substantially at or towards the centre of said base. Alternatively, the or each impingement may be arranged to be eccentric with respect to the centre of said base the base.

In further embodiments the or each impingement/may be arranged on the side wall.

The container may comprise handling means such as a handle and/or gripping portion. In other embodiments the handling means may comprise a thermally isolating chamber such as a thermal jacket. The gripping means may comprise a textured portion of the container, which may also be insulating, in some embodiments. The handle may comprise an insulating material.

According to a second aspect of the invention there is provided a method of creating a frothed beverage or a frothed component of a beverage with a container of the first aspect of the invention comprising the steps of: filling said container with a beverage or component thereof; immersing a steam outlet of a steam wand in said beverage or component; supplying steam through said steam wand into said beverage or component.

In some embodiments the beverage or component comprise milk, a creamer or a milk substitute. The milk may comprise whole, skimmed, semi-skimmed or UHT milk, for example.

According to a third aspect of the invention there is provided a use of a container of the first aspect of the invention for frothing a beverage or component of a beverage.

The use may comprise using the container in combination with a steam wand of a beverage preparation machine.

According to a fourth aspect of the invention there is provided an apparatus for creating a frothed beverage comprising: a container according to the first aspect of the invention; a steam wand; and a steam supply.

The apparatus may comprise a coffee machine.

According to a fifth aspect of the invention there is provided a system for frothing a beverage or a component of a beverage, the system comprising a beverage machine having a steam wand, and a container of the first aspect of the invention. The beverage machine is preferably a coffee machine.

### DETAILED DESCRIPTION OF THE INVENTION

In order that the invention may be more clearly understood, embodiments thereof will now be described, by way of example only, with reference to the accompanying drawings of which:

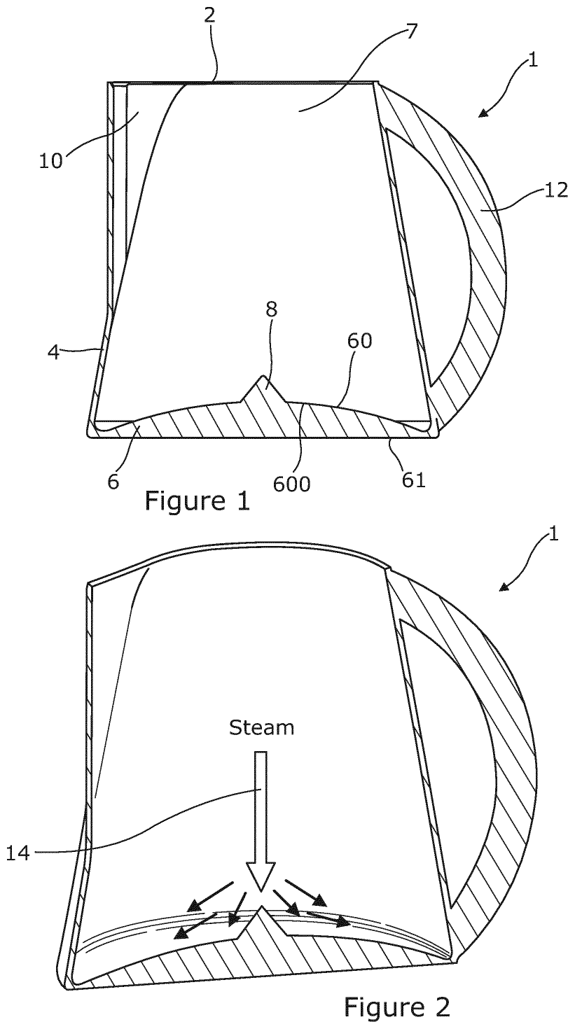

FIG. 1 illustrates a cross sectional view of a first embodiment of a container for frothing a beverage according to the first aspect of the invention;

FIG. 2 illustrates a cross sectional view of the embodiment of FIG. 1 with highlighted steam flow directions when steam is injected into said container during the foaming process.

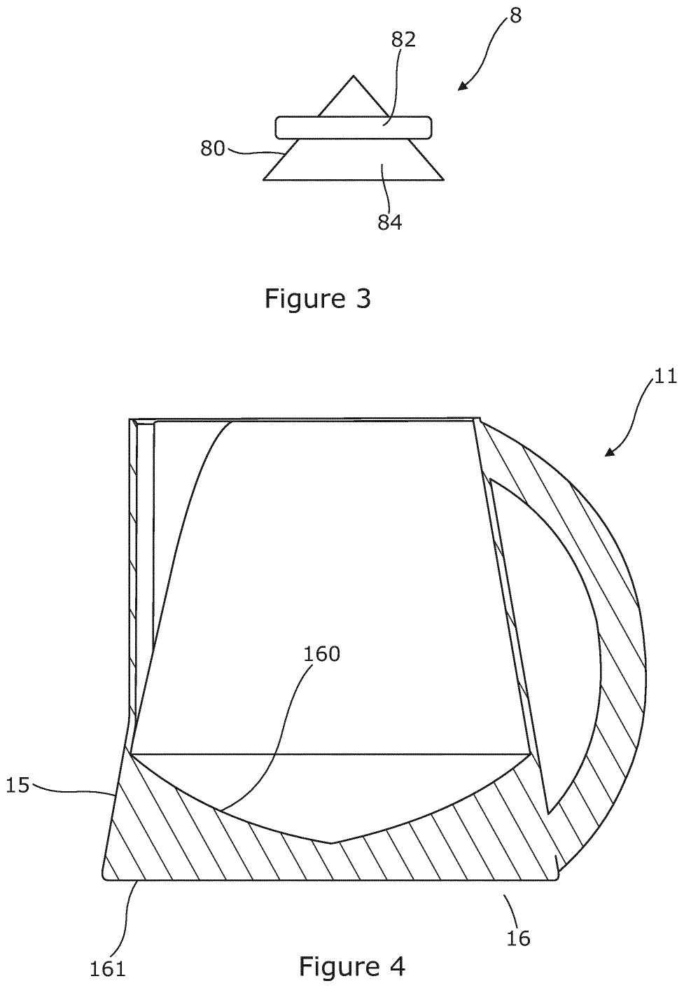

FIG. 3 illustrates a cross sectional view of an impingement in the form of a secondary protrusion of the first aspect of the invention.;

FIG. 4 illustrates a cross sectional view of a second embodiment of the first aspect of the invention;

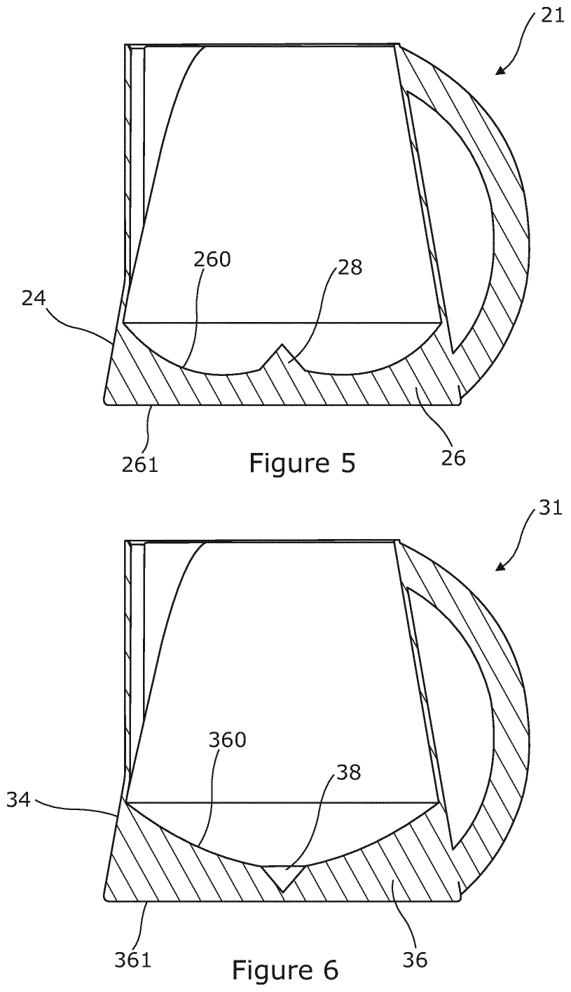

FIG. 5 illustrates a cross sectional view of a third embodiment of the first aspect of the invention;

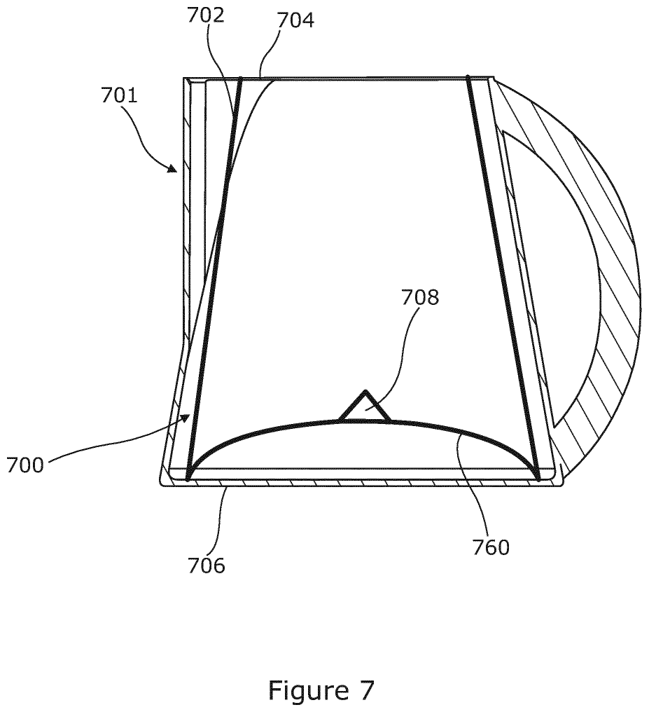

FIG. 6 illustrates a cross sectional view of a fourth embodiment of the first aspect of the invention;

FIG. 7 illustrates a cross sectional view of a fifth embodiment of the first aspect of the invention, comprising a container with an insert.

Referring to the Figures, like numbers represent like components.

Referring firstly to FIG. 1 a side cross-sectional view of an embodiment of a container (1) for frothing a beverage is shown.

The embodiment comprises a container (1) for frothing a beverage comprising an opening (2) into a side wall (4) which is connected to a substantially circular base (6), which together define an inner volume (7) of the container (1). The base (6) comprises an inner surface (60) which faces the opening (2) and an outer surface (61) which represents the external bottom of the container (1). The two surfaces (60, 61) define a primary protrusion (600), generally dome-shaped, which extends into the inner volume (7). Protruding from the inner surface (60) of the protrusion (600) toward the inner volume (7) there is provided an impingement in the form of a secondary protrusion (8). The secondary protrusion is generally conical spike-shaped. The container (1) further comprises a spout (10) extending from the side wall (4) and a handle (12) extending from the side wall (4) in a position diametrically opposite to the spout (10).

The side wall (4) of the container (1) has a substantially cylindrical shape, but is also partially tapered to form a truncated cone shape, where the largest diameter corresponds to the base (6) of the container (1) and the smallest diameter corresponds to the top opening (2) or vice versa.

In other embodiments the base (6) can have a different shape such as for instance square, oval, or polygonal.

The spout (10) extends from the perimeter of the opening (2) along the side wall (4) toward the base (6) for at least half of the height of the container (1) and tapers inwardly towards the base.

Diametrically opposite to the spout (10) on the side wall (4) a handle (12) is provided to allow the operator to safely lift and use the container (1) when its surface is heated by the steam injected into the beverage. The handle (12) is in the form of a standard handle for cups, but different handles can be used. For example, any handling means which allows insulation of the container (1) with respect to the operator's hand during the foaming process can be used. This includes a thermally isolating chamber and/or gap (such as a thermal jacket) between the internal and external surfaces of the side wall (6) and/or thermally isolating gripping materials directly and/or indirectly applied to the external surface of the side wall (6), as for example polymeric material such as polypropylene (PP), polyethylene (PE), polyethylene terephthalate (PET), polylactic acid (PLA), polyamide (PA), polycarbonate (PC), rubber, silicone and/or a combination thereof, wood and/or glass can be used.

The protrusion (600) of the base (6) of the container (1) of FIG. 1 confers to the base a domed shape from the apex of which an impingement in the form of a secondary protrusion (8) extends toward the inner volume (7). Said impingement is in the shape of a conical spike, having an inverted V cross-sectional shape, but other shapes can be used for instance a truncated cone, hemisphere, wedge, or bead shape, for example. In further embodiments (not shown) the V shape of the secondary protrusion (8) can be reversed to extend into the domed protrusion (600) of the base (6), forming a secondary depression, and so that the apex of the V shape points away from the opening (2) of the container (1) towards the outer surface (61).

The secondary protrusion (8) is furthermore positioned at substantially the centre of the inner surface (60) of the base (6), but other positions are possible, for example an eccentric position with respect to the centre of the inner surface (60) can be selected.

In addition, although secondary protrusion (8) of the container (1) of Figure lis a single impingement, in other embodiments there may be multiple impingements distributed in a structured pattern, for example in a matrix and/or in a circle or concentric circles. These multiple impingements can also be distributed randomly on the inner surface (60) of the primary protrusion (600) and/or base (6).

In other embodiments the base (6) can also present a primary protrusion (600) which is partially set in and spaced apart from the side wall (4), rather than extending from the periphery of the base at the side wall. The secondary protrusion (8) can be placed on this primary protrusion (600) in a central or in an eccentric position with respect to the primary protrusion (600). Furthermore, multiple secondary protrusions (8) can be used and arranged in a structured and/or random pattern.

In some embodiments the primary protrusion (600) can be positioned on the side wall (4) and secondary protrusion/protrusions (8) can be placed on the primary protrusion (600) in the same way as described for FIG. 1. In these embodiments the primary protrusion (600) is not part of the base (6), but it projects laterally from the side wall (4) toward the inner volume (7). In these embodiments the primary protrusion (600) can partially or entirely engage the side wall (4) of the container (1), being positioned and projecting from the side wall (4) along the side wall (4) perimeter towards the inner volume (7), in order to directly and/or indirectly intercept the stream of steam coming out from a conventional steam/froth wand, in use. Such protrusion (600) can also comprise a secondary protrusion (8), which intercepts the steam stream, splitting the steam flow and generating an intense turbulent movement inside the beverage. The secondary protrusion (8), when positioned beneath the steam stream of a steam/froth wand intercepts the stream and splits the steam flow deviating it in multiple directions, radially, allowing the generation of a whirling movement (e.g. turbulence) within the beverage which facilitates incorporation of air and therefore the creation of a fine foam.

Referring now to FIG. 2, a container (1) as described in FIG. 1 is represented in side cross-sectional view, together with an indication of steam flow direction (14) during the foaming process (from a steam wand, not shown).

In use the container (1) of FIGS. 1 is filled with a beverage to be foamed or a component of a beverage to be foamed. This beverage, or component, can be fresh and/or UHT milk (skimmed or whole) and/or a non-dairy milk as for example oat, rice, coconut, almond, soy milk. Other beverage preparations can be chocolate preparations for instance. The container (1) is then positioned by the operator beneath the froth wand of a conventional beverage preparation machine (such as a coffee machine, for example, not shown) in such a way that the outlet or nozzle of the froth wand is immersed into the beverage and points generally towards the secondary protrusion (8). Steam is then sent to the froth wand to foam the beverage. After having placed the jug beneath the steam flow direction it can be left in this position, without needing further manual operation of the jug by the operator. The container (1) is kept in the same position during the whole foaming process. The steam flow accesses the inner volume (7) along the direction (14) and is intercepted by the secondary protrusion (8) which splits the steam flow radially, allowing the generation of a turbulent flow which creates a vortex which allows incorporation of steam and air, generating a fine foam. Once a certain temperature is reached (between 60 and 70° C.) the foaming process is stopped and the steam flow is interrupted and a finely foamed beverage is obtained.

A preferred shape of said secondary protrusion (8) for use in a container of the invention is shown in FIG. 3). A secondary protrusion (8) comprises a cone shape (80) having a cone body (84) and a flat toroid structure (82) projecting around an outer surface of said cone body (84). The secondary protrusion (8) of FIG. 3 may be used in the container (1) of FIG. 1 or any other container.

Referring now to FIG. 4, a side cross-sectional view of a further embodiment of a container (11) of the invention is shown.

The container (11) comprises a base (16) which includes spaced apart inner (160) and outer (161) surfaces. The inner surface (160) is concave and its perimeter abuts an internal surface of a side wall (15). The inner surface (160) forms a primary depression in the base (16).

In these embodiments when a stream of steam is injected into the container (11) it hits the concave surface (160), deviating its direction and generating turbulence within the beverage contained in the container (11). This turbulence allows incorporation of air generating a fine layer of micro-bubbles (micro foam).

Referring now to FIG. 5, a side cross-sectional view of a further embodiment of the container (21) of the first aspect of the invention is shown.

The container (21) comprises a side wall (24) and a base (26), which is defined by an inner (260) and outer (261) surface, defining a primary concave depression. A single secondary protrusion (28), in the form of a conical spike is positioned substantially centrally on the inner surface (260) of the base (26), extending into the inner volume of the container (21).

The secondary protrusion (28) can comprise multiple protrusions and can be placed centrally or eccentrically with respect to the base (26) centre. In the case of multiple protrusions these can be displayed in a random and/or regular structure/deployment.

The secondary protrusion/protrusions (28) can also be of the same type as described in FIG. 3.

In some other embodiments the inner and outer surfaces of FIGS. 4 and 5 (160, 161 and 260, 261 respectively) may form a flat base, rather than a concave or convex base. Single or multiple protrusion/protrusions can be placed centrally or eccentrically on the flat base. Said protrusion/protrusions can be as described for FIG. 3.

In some other embodiments a primary depression can be generated on the side wall (4) for example a concave area formed in the side wall (4), and impingement/impingements in the form of secondary protrusion/protrusions can be placed within this depression in the same way as described for FIG. 1.

Referring to FIG. 6, a side cross-sectional view of a further container (31) of the invention is represented.

Said container (31) comprises a side wall (34) and a base (36) defined by an inner and an outer surface (360, 361). The inner surface (360) of the base (36) has a concave shape. An impingement in the form of a secondary depression (38) has a V cross-sectional shape or conical spike shape and extends into said base (36).

The secondary depression (38) is in the shape of a cone formed or cut into the base (36), but any further shape can be used, for example a hemisphere, a wedge or cubic shape. There may be a single secondary depression (38) or multiple secondary depressions, which can be placed centrally or eccentrically with respect to the base (36) centre.

Multiple protrusions and/or depressions can be displayed in a random and/or regular pattern/deployment.

The containers (1, 11, 21, 31) of FIGS. 1, 2, 4, 5, 6 can be made of stainless-steel material, ceramic and/or polymeric substrates and/or a combination thereof.

Referring finally to FIG. 7 a container (701) is shown with an insert (700) connected thereto, to form a container of the first aspect of the invention. The container (701) includes a flat base (706) and a side wall (704) extending around the base (706).

The insert (700) comprises connecting means (702) to connect said insert (700) to the side wall (704) of the beverage frothing container (701). The insert (700) includes a primary protrusion (760) in the form of a dome-shaped base which further comprises an impingement in the form of a secondary spike-shaped protrusion (708) extending from the top of the dome-shaped primary-protrusion (760).

The insert (700) is removably connected to said state-of-the-art beverage frothing container (701) through said connecting means (702) which may comprise for instance a hook, a resilient clamp, a bayonetted connection, a threaded connection (such as a screw thread) and/or a snap on connection, depending on the configuration of the edge of the side wall (704).

The insert (700), when connected to the container side wall (704), forms a primary protrusion extending from the base (706), within the container (701), thus transforming the container (704) to a container according to the invention.

The primary and secondary (760, 708) protrusions may be of the type already described for the embodiment of FIGS. 1 and 3, for example.

The insert (700) can be made of stainless steel, polymeric substrate, rubber silicone, glass, ceramic and/or a combination thereof, for example.

In use, once inserted into the state-of-the-art beverage frothing container (701) and fixed to the side wall (704) through the connecting means, the insert (700) operates as described for the container (1) of FIGS. 1 and 6.

All of the containers (1, 11, 21, 31, 701) of FIGS. 1, 2, 4, 5, 6 and 7 can be used directly beneath a steam wand of a beverage machine, particularly a coffee machine, and filled with a suitable beverage material or component, such as milk.

1. A container for frothing a beverage or component of a beverage, comprising a side wall and a base which define an inner volume, and an opening for filling said inner volume with said beverage or component, wherein an interior surface of said base and/or side wall comprises at least a primary protrusion and/or a primary depression, connected thereto and/or formed therein.

2. A container for frothing a beverage according to claim 1 wherein said primary protrusion comprises a convex protrusion.

3. A container for frothing a beverage according to claim 1 wherein said primary depression comprises a concave depression.

4. A container for frothing a beverage according to claim 1 wherein said primary protrusion and/or primary depression further comprises an impingement.

5. A container for frothing a beverage according to claim 4 wherein said impingement comprises a secondary protrusion and/or secondary depression.

6. A container for frothing a beverage according claim 5 wherein said primary protrusion comprises a convex protrusion and said impingement comprises a secondary protrusion.

7. A container for frothing a beverage according to claim 6 wherein said secondary protrusion extends from said convex protrusion.

8. A container for frothing a beverage according to claim 7 wherein said secondary protrusion is positioned centrally with respect to the convex protrusion and/or said base.

9. A container for frothing a beverage according to claims 5 wherein each secondary protrusion and/or depression comprises a shape independently selected from the group comprising: a dome, a spike, a hemisphere, a cone, a bead, and a wedge.

10. A container for frothing a beverage according to claim 5 wherein said secondary protrusion and/or secondary depression comprises a plurality of impingements.

11. A container for frothing a beverage according to claim 10 wherein said plurality of impingements are arranged in a pattern.

12. A container for frothing a beverage according to claim 10 wherein said plurality of impingements are randomly arranged.

13. A container for frothing a beverage according to claim 4 wherein the or each impingement is arranged on the centre of said base.

14. A container for frothing a beverage according to claim 4 wherein the or each impingement is positioned eccentrically with respect to the centre of said base the base.

15. A container for frothing a beverage according to claim 4 wherein the or each impingement is arranged on the side wall.

16. A container for frothing a beverage according to claim 1 wherein the primary protrusion and/or depression comprises an insert detachably or fixedly connected to said side wall and/or said base.

17. A container for frothing a beverage according to claim 5, wherein the primary protrusion and/or depression comprises an insert detachably or fixedly connected to said side wall and/or said base, and wherein said secondary protrusion and/or depression is connected to or formed into said insert.

18. A container for frothing a beverage according to claim 16 wherein said insert comprises a base and/or side wall connector, such as a hook, resilient clamp, bayonetted connector, threaded connector or snap on connector.

19. A container for frothing a beverage according to claim 1 wherein the container comprises handling means and/or a spout.

20. A method of creating a frothed beverage with a container according to claim 1 comprising the steps of:
filling said container with a beverage or a component of a beverage;
immersing a steam outlet of a steam wand in said beverage or component;
supplying steam through said steam wand into said beverage or component.

21. Use of a container according to claim 1 for frothing a beverage or component of a beverage.

22. A system for creating a frothed beverage or component of a beverage comprising:
a container according to claim 1; and
a beverage machine comprising a steam wand.

23. A system as claimed in claim 22, wherein the beverage machine is a coffee machine.
